(19) United States
(12) Patent Application Publication
(10) Pub. No.: US 2026/0307669 A1
(43) Pub. Date: Oct. 8, 2026

(54) A Method of Using a Driver Assistance System for Passing Through a Car Wash System of an Automated Motor Vehicle in a Crash Test for the Motor Vehicle

(71) Applicant: Bayerische Motoren Werke Aktiengesellschaft, Muenchen (DE)

(72) Inventors: Tobias DUWENSEE, Muenchen (DE); Bruno ENGELMANN, Poing (DE)

(21) Appl. No.: 18/993,048

(22) PCT Filed: Jun. 12, 2023
(86) PCT No.: PCT/EP2023/065624

§ 371 Date: Jan. 10, 2025

(30) Foreign Application Priority Data
Jul. 11, 2022 (DE) 10 2022 117 223.6

(51) Int. Cl. B60W 50/08; B60W 30/09; B60W 50/14

(52) U.S. Cl. CPC B60W 50/082; B60W 50/14; B60W 30/09; B60W 2050/146; B60W 2540/215

(57) ABSTRACT

A method of using a driver assistance system for passing through a car wash system of an automated motor vehicle in a crash test for the motor vehicle, wherein crash-avoiding driver assistance systems of the motor vehicle are deactivated while the driver assistance is activated.

### BACKGROUND AND SUMMARY

The present disclosure relates to a method of using a driver assistance system for passing through a car wash system of an automated motor vehicle in a crash test for the motor vehicle.

Producers of motor vehicles, in particular of automobiles, carry out crash tests to meet approval requirements. For this purpose, brand-new motor vehicles are accelerated on a crash path, for example, to up to 80 km/h, and then driven into an obstacle, such as a wall.

Crash protection functions of the motor vehicle, such as a crash detection, a trigger function of airbags, etc., which are to be assigned to the passive safety systems, have to be active in this case. That is to say, a state of the protective functions is produced in this regard which the motor vehicle also has in later use in the field or which a user of the motor vehicle finds.

Against the background of this prior art, an object of the present disclosure is to specify a device and/or a method which are each suitable for enhancing the above-mentioned prior art.

Accordingly, the object is achieved by the use of a driver assistance system for passing through a car wash system of an automated motor vehicle in a crash test for the motor vehicle, wherein crash-avoiding driver assistance systems of the motor vehicle are deactivated when the driver assistance system is activated.

In other words, it is proposed to use a customer function actually intended for another purpose, here the driver assistance system for passing through a car wash system or a so-called car wash system mode, for the crash test.

Such a driver assistance system is described in basic principles, for example, in DE 10 2016 009 552A1 , which relates to a method for preparing a vehicle for a car wash in a car wash system. The car wash system mode of the vehicle described in DE 10 2016 009 552 A1 comprises a plurality of procedures which have to be carried out to secure the vehicle against penetrating wash water or against damage to the vehicle. This car wash system mode initially includes closing side windows and roof openings, wherein the positions of the open side windows and of the roof opening are stored in the control unit. At the same time, the side mirrors are folded in and, if the vehicle is equipped therewith, a parking aid or even a rain sensor is deactivated.

Furthermore, such a driver assistance system is described in basic principles, for example, in DE 10 2015 011 498A1 , which describes a method for carrying out a driving program for a vehicle in which a car wash system mode is carried out manually by actuating the driving program switch or by a two-handed operation with actuation of the operating knob of the electrical parking brake and actuating the ignition lock or a speech operation or a menu-guided operation by way of a vehicle-side display device and/or an app-controlled operation by way of a mobile electronic terminal. The activation of this car wash system mode enables an automatic deactivation of selected comfort functions of the vehicle or the output of information to the driver. These comfort functions include, for example, deactivating a security mechanism, applying the parking brake or automatically engaging the parking lock, deactivating the automatic functions of the windshield wipers, and deactivating an ultrasound-based or radar-based parking aid. At the same time, mechanical components such as side windows or a sliding roof or the roof of a convertible are moved into the closed state.

The present driver assistance system differs here from the above-described driver assistance systems at least in that when the driver assistance system is activated, crash-Attorney avoiding driver assistance systems of the motor vehicle are deactivated. In addition, the above with reference to DE 10 2015 011 498 A1 and/or DE 10 2016 009 552 A1 can also be implemented in the driver assistance system. Notwithstanding this, depending on the type of the crash (for example, rear crash or frontal crash), various positions of windows and/or side windows can be settable or set. However, it is decisive that the driver assistance system according to the present disclosure is also suitable for carrying out a crash test, during which in particular a frontal crash of the motor vehicle with an obstacle can occur, since due to the deactivation of the crash-avoiding driver assistance systems, no automated intervention of the motor vehicle in lateral and/or longitudinal guidance of the motor vehicle takes place, which would prevent the crash or the collision.

That is to say, a mode or a driver assistance system already present in the motor vehicle was found, in which future crash tests can run under laboratory or experimental conditions. In this mode, the crash-avoiding assistance systems are deactivated (e.g., emergency braking, evasion, etc.).

The customer can use this mode in the motor vehicle in the field in order to let themselves be pulled through a car wash installation, for example. The vehicle neither undertakes an evasion maneuver from lateral washing brushes in the car wash installation or car wash system, nor does emergency braking take place when, for example, a washing brush and/or a dryer moves toward the vehicle from the front.

Possible refinements of the above-described use of the driver assistance system are explained in detail hereinafter.

When the driver assistance system is activated, passive safety systems, in particular all passive safety systems, of the motor vehicle can be activated.

The above-described crash-avoiding safety systems can be assigned to the active safety or the active safety systems of the motor vehicle. Crash-avoiding safety systems are to be understood in the present case as those which intervene in a preventative manner before a crash and furthermore preferably exclusively those which perform an active intervention in the lateral and/or longitudinal guidance of the motor vehicle in an automated manner.

Passive safety systems can be understood as those which intervene or trigger directly during a crash (so-called crash functions), such as airbags and/or belt tensioners, but also those which intervene or trigger a specific short time after the crash (so-called post-crash functions), such as an automatic or automated placement of an emergency call and/or an automatic or automated performance of a braking operation of the motor vehicle after the crash.

The use can comprise providing the automated motor vehicle on a motor vehicle test stand, activating the driver assistance system, so that the crash-avoiding assistance systems of the motor vehicle are deactivated, and performing the crash test or the test with an activated driver assistance system.

The crash-avoiding driver assistance systems can comprise an emergency braking assistant and/or a driver assistance system for performing an automated evasion maneuver.

An emergency braking assistant can be understood as a driver assistance system which, in the event of an imminent collision, performs a braking operation of the motor vehicle in an automated manner, i.e. an active intervention in the longitudinal guidance of the motor vehicle.

A driver assistance system for performing an automated evasion maneuver or an evasion assistant can be understood as a driver assistance system which, in the event of an imminent collision, performs a direction change of the motor vehicle by way of a steering function, i.e. an active intervention in the lateral guidance of the motor vehicle, in an automated manner.

Furthermore, driver assistance systems such as an ABS (antilock braking system) and/or an ESP (electronic stability program) of the motor vehicle can also be deactivated.

An electronic stability program can be understood as an electronic driver assistance system which is supposed to counteract the swerving of the motor vehicle by braking individual wheels of the motor vehicle. This driver assistant is also called ESC (electronic stability control) or driving dynamics controller. An antilock braking system can be understood as a driver assistance system which prevents the wheels of the motor vehicle from locking up during a braking operation. This can be carried out by repeatedly decreasing and increasing the brake pressure.

The use can comprise a visual display or output of a current status of the driver assistance system in the motor vehicle.

The current status of the driver assistance system can comprise the statuses active, inactive, and/or activatable.

The driver assistance system can be activatable and/or deactivatable via a central display installed in the motor vehicle by way of a user input.

The driver assistance system can be activatable from a test stand mode of the motor vehicle.

It is conceivable that the motor vehicle is prevented from driving away of its own accord when the driver assistance system is activated when the driver assistance system is activated from the test stand mode of the motor vehicle.

Additionally or alternatively, a time span for which the driver assistance system remains active after the activation thereof can be longer in comparison to an activation from a non-test stand mode if the driver assistance system is activated from the test stand mode of the motor vehicle.

In other words, the test stand mode can be a mode which puts the motor vehicle in a status upon its activation in which this motor vehicle cannot drive away of its own accord. This is predominantly used for work safety for workers on the test stand. The driver assistance system can be started when this test stand mode is active, so that both the crash-avoiding driver assistance systems of the motor vehicle are deactivated and the motor vehicle is also prevented from driving away of its own accord by the test stand mode.

This has the advantage that the driver assistance system does not have to be modified for the use on the test stand. Furthermore, a duration for which the driver assistance system remains activated before it is deactivated in an automated manner can be extended if the test stand mode is active at the time of the activation of the driver assistance system.

The driver assistance system can be activatable, in particular exclusively, when no gear is engaged in a transmission of the motor vehicle and the motor vehicle is stationary.

The description above can be summarized as described hereinafter, wherein the following statements refer to a specific implementation which does not limit the disclosure: A mode has been identified with the car wash system mode in which all crash and post-crash-side functions are active and can be secured, which can be started simply and can clearly visualize the status “active” as feedback for the test stand employee. The car wash system mode can be able to be activated and/or deactivated, for example, via a touch input in the central display. This applies both for the customer in the car wash system from the mode “driving” and for the test stand from the test stand mode. Optionally, a pop-up signaling an ability to activate the car wash system mode can appear in the central display of the motor vehicle when a neutral gear is engaged and the vehicle is stationary. It is conceivable that it is possible to jump directly into a menu via the pop-up in order to be able to activate the car wash system mode. The status display “car wash system active” can take place, for example, in the display of the instrument cluster and/or a chamber lamp can be integrated and can light up accordingly. The car wash system mode can remain active for the crash for a longer period of time, for example, for at least 3 hours, when it is started from the test stand mode. This can be necessary since unplanned delays can occur rapidly on the crash path or on the test stand. During this time, the state of charge of the onboard electrical system battery and the HV system (high-voltage system) can be monitored and it can be recharged if necessary. At no time can the automobile therefore drive away of its own accord. In the field, the car wash system mode can be started from the mode “driving” and can be deactivated after a shorter time span, for example, after 35 minutes, so that the motor vehicle is in the so-called status “residing”. Excessive discharge of the battery can thus be avoided in the field.

### BRIEF DESCRIPTION OF THE DRAWING

An embodiment is described hereinafter with reference to FIG. 1.

FIG. 1 schematically shows a flow chart of a method of using a driver assistance system for passing through a car wash system of an automated motor vehicle in a crash test for the motor vehicle.

### DETAILED DESCRIPTION OF THE DRAWING

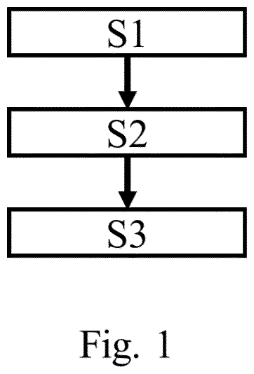

As can be seen from the flow chart shown in FIG. 1, the use of the driver assistance function or the driver assistance system essentially has three steps S1-S3.

The driver assistance system used for the motor vehicle has the suitability, upon or after its activation, for putting the motor vehicle, in particular for a predetermined period of time, in a status such that the motor vehicle can pass through a car wash system.

In the activated state or with activated driver assistance function, crash-avoiding driver assistance systems of the motor vehicle are deactivated for this purpose.

It has been established that this status is not exclusively suitable, however, for passing through the car wash system with the motor vehicle, but rather also for performing a crash test for or with the motor vehicle, in which the motor vehicle is subjected, for example, to a frontal crash.

Among other things, this is because the crash-avoiding driver assistance systems can comprise, for example, an emergency braking assistant and/or a driver assistance system for performing an automated evasion maneuver. These are deactivated in the car wash system, so that no automated reaction of the motor vehicle takes place to elements or parts of the car wash system approaching the motor vehicle and/or contacting the motor vehicle. In the case of the crash test, this means that no preventive reaction of the motor vehicle takes place to the obstacle with which the motor vehicle collides.

It is advantageous here that with activated driver assistance function, in particular all, passive safety systems of the motor vehicle are activated, so that they can be tested or secured during the crash test.

In other words, the presently proposed use relates to a misuse of a customer function, namely the above-described driver assistance function for passing through the car wash system, which is used in the context of the proposed use on a crash test stand.

In a first step S1 of the method, the automated motor vehicle is provided on a motor vehicle test stand and the motor vehicle is put into a test stand mode, in which driving off of the motor vehicle of its own accord is prevented or is not possible when the driver assistance function is activated. The motor vehicle is furthermore put into a state in which the driver assistance function is activatable, i.e. no gear is engaged in a transmission of the motor vehicle (for example, the position “neutral” in an automatic transmission) and the motor vehicle is stationary (i.e. the motor vehicle does not drive). It is conceivable that it is signaled or output in this state by way of a visual display that the driver assistance function is currently in a deactivated state, but is activatable. This can take place, for example, via a pop-up in a central display installed in the motor vehicle.

In a second step S2 of the method, the driver assistance function is activated from the test stand mode of the motor vehicle, so that it is still not possible for the motor vehicle to drive off of its own accord, even with the driver assistance function activated. The driver assistance function can be activated, for example, via the central display installed in the motor vehicle by way of a user input. It is conceivable that in this state it is signaled or output by way of the visual display that the driver assistance function is currently in an activated state. Since the driver assistance function is activated from the test stand mode of the motor vehicle, a time span for which the driver assistance function remains active after the activation thereof is longer in comparison to an activation from a non-test stand mode (for example, by a customer in the field). The crash test, which usually lasts longer than passing through the car wash system, can thus be performed without interruption. The crash-avoiding assistance systems of the motor vehicle are deactivated after the activation and the passive safety systems of the motor vehicle are activated.

In a third step S3 of the method, the crash test is performed with activated driver assistance function on the motor vehicle test stand, i.e. with deactivated crash-avoiding assistance systems of the motor vehicle and activated passive safety systems of the motor vehicle.

1.-10. (canceled)

11. A method of using a driver assistance system for passing through a car wash system of an automated motor vehicle in a crash test for the motor vehicle, wherein when the driver assistance system is activated, crash-avoiding driver assistance systems of the motor vehicle are deactivated.

12. The method according to claim 11, wherein when the driver assistance system is activated, passive safety systems of the motor vehicle are activated.

13. The method according to claim 11, comprising:
providing the automated motor vehicle on a motor vehicle test stand, activating the driver assistance system, so that the crash-avoiding assistance systems of the motor vehicle are deactivated, and
performing the crash test with activated driver assistance system.

14. The method according to claim 11, wherein the crash-avoiding driver assistance systems comprise an emergency braking assistant and/or a driver assistance system for performing an automated evasion maneuver.

15. The method according to claim 11, comprising a visual display of a current status of the driver assistance system in the motor vehicle.

16. The method according to claim 15, wherein the current status comprises the states active, inactive, and/or activatable.

17. The method according to claim 11, wherein the driver assistance system is activatable and/or deactivatable via a central display installed in the motor vehicle by means of a user input.

18. The method according to claim 11, wherein the driver assistance system is activatable from a test stand mode of the motor vehicle.

19. The method according to claim 18, wherein driving off of the motor vehicle of its own accord is prevented when the driver assistance system is activated and/or a time span for which the driver assistance system remains active after the activation thereof is longer in comparison to an activation from a non-test stand mode when the driver assistance system is activated from the test stand mode of the motor vehicle.

20. The method according to claim 11, wherein the driver assistance system is activatable when no gear is engaged in a transmission of the motor vehicle and the motor vehicle is stationary.
